(19) United States
(12) Patent Application Publication
(10) Pub. No.: US 2017/0116633 A1
(43) Pub. Date: Apr. 27, 2017

(54) PAYMENT APPARATUS, CONTROL METHOD, PROGRAM, AND PAYMENT SYSTEM

(71) Applicant: NEC Corporation, Tokyo (JP)

(72) Inventor: Shinpei CHIHARA, Tokyo (JP)

(73) Assignee: NEC Corporation, Tokyo (JP)

(21) Appl. No.: 15/127,200

(22) PCT Filed: Mar. 13, 2015
(86) PCT No.: PCT/JP2015/057522

§ 371 Date: Sep. 19, 2016

(30) Foreign Application Priority Data
Mar. 19, 2014 (JP) 2014-056819

(51) Int. Cl. G06Q 30/02; G06Q 20/34

(52) U.S. Cl. CPC G06Q 30/0207; G06Q 20/34

(57) ABSTRACT

A payment apparatus (2000) includes a discount amount acquisition unit (2040), a determination unit (2060), and a payment unit (2080). The discount amount acquisition unit (2040) acquires a discount amount. The determination unit (2060) determines whether a discount is applied to a purchase price of a product on the basis of a use history of a target card. The payment unit (2080) applies a discount to the purchase price of a product on the basis of the discount amount in a case where the determination unit (2060) determines that a discount is applied, and performs payment by card using the target card.

### TECHNICAL FIELD

The present invention relates to a payment apparatus, a control method, a program, and a payment system.

### BACKGROUND ART

Systems that perform payment using electronic money cards have been in widespread use. Here, among the electronic money cards, there are some cards that we cannot obtain unless we purchase them by paying their prices. The requirement for the prices to be paid in order to obtain the cards is unfavorable to users, which results in an adverse effect on the widespread use of the electronic money cards.

Related arts relating to the systems that perform payment include Patent Documents 1 and 2. Patent Document 1 discloses a charging system of an electric automobile in a parking lot provided in facilities such as a shopping center. Specifically, the available amount of recharge power of an electric automobile is given to a user, depending on a payment amount when the user uses the facilities. Since the electric automobile is charged by setting the available amount of recharge power as an upper limit, payment is not required when the electric automobile is charged.

Patent Document 2 discloses a parking charging fee system in which, in a parking lot provided with charging facilities of an electric automobile, a time for which parking is available free of charge is calculated on the basis of an amount of money being used for shopping and a charging fee.

### RELATED DOCUMENTS

### Patent Documents

[Patent Document 1] Japanese Unexamined Patent Application Publication No. 2012-244785

[Patent Document 2] Japanese Unexamined Patent Application Publication No. 2012-095432

### SUMMARY OF THE INVENTION

The inventor has considered a way of reducing the burden of a user who purchases the electronic money card by constructing a payment apparatus that provides a discount when payment is performed using an electronic money card. None of the respective related art documents make mention of a reduction in the burden of a user who purchases an electronic money card.

Here, since payment requiring a discount is restricted, the payment apparatus needs to appropriately determine whether a discount is required in a payment process. Further, generally, the amount of information capable of being stored in an electronic money card is small. Thus, even in a situation where the amount of information capable of being acquired from the electronic money card is small, the payment apparatus needs to be capable of appropriately determining whether a discount in the payment process.

The present invention is contrived in view of the above problems. An object of the present invention is to provide a technique for appropriately applying a discount in payment using an electronic money card.

According to the present invention, there is provided a payment apparatus including: a discount amount acquisition unit acquiring a discount amount; a determination unit determining whether or not to apply a discount to payment by card using a target card on the basis of a use history of the target card, the target card being electronic money card of a target; and a payment unit applying a discount to payment by card using the target card on the basis of the discount amount, in a case where the determination unit determines to apply a discount.

According to the present invention, there is provided a control method which is executed by a computer. The control method includes: a discount amount acquisition step of acquiring a discount amount; a determination step of determining whether or not to apply a discount to payment by card using a target card on the basis of a use history of the target card, the target card being electronic money card of a target; and a payment step of applying a discount to payment by card using the target card on the basis of the discount amount, in a case where the determination unit determines to apply a discount.

According to the present invention, there is provided a program causing a computer to have a function of each functional configuration unit included in the payment apparatus provided by the present invention, to thereby cause the computer to have a function of operating as the payment apparatus provided by the present invention.

According to the present invention, there is provided a technique for appropriately applying a discount in payment using an electronic money card.

### BRIEF DESCRIPTION OF THE DRAWINGS

The above-mentioned objects, other objects, features and advantages will be made clearer from the preferred embodiments described below, and the following accompanying drawings.

FIG. 1 is a block diagram illustrating a payment system according to Embodiment 1.

FIG. 2 is a diagram illustrating a use history stored in a use history storage unit in a table form.

FIG. 3 is a block diagram illustrating a hardware configuration of a payment apparatus.

FIG. 4 is a flow diagram illustrating a flow of processes which are executed by the payment apparatus of Embodiment 1.

FIG. 5 is a block diagram illustrating a payment apparatus of Embodiment 2 including a maximum-number-of-storage items acquisition unit.

FIG. 6 is a flow diagram illustrating a flow of processes in a case where a determination unit performs a determination in a determination method 2.

FIG. 7 is a block diagram illustrating a payment system of Embodiment 3.

FIG. 8 is a diagram conceptually illustrating a process performed by a determination unit of Embodiment 3.

FIG. 9 is a flow diagram illustrating a flow of processes executed by a payment apparatus of Embodiment 3.

FIG. 10 is a block diagram illustrating a payment system of Modification Example 3-1.

FIG. 11 is a block diagram illustrating a payment system of Embodiment 4.

FIG. 12 is a diagram illustrating a use history stored in a second use history storage unit in a table form.

FIG. 13 is a diagram illustrating a use history stored in the second use history storage unit in association with a product ID in a table form.

FIG. 14 is a flow diagram illustrating a flow of processes executed by a payment apparatus of Embodiment 4.

FIG. 15 is a block diagram illustrating a payment system of Embodiment 5.

FIG. 16 is a flow diagram illustrating a flow of processes executed by a payment apparatus of Embodiment 5.

FIG. 17 is a block diagram illustrating a payment system of Embodiment 6.

FIG. 18 is a flow diagram illustrating a flow of processes executed by a payment apparatus of Embodiment 6.

FIG. 19 is a block diagram illustrating a payment system of Embodiment 7.

FIG. 20 is a flow diagram illustrating a flow of processes executed by a payment apparatus of Embodiment 7.

FIG. 21 is a block diagram illustrating a charging apparatus of Example 1 together with its usage environment.

FIG. 22 is a block diagram illustrating a charging apparatus of Example 2 together with its usage environment.

FIG. 23 is a block diagram illustrating a charging apparatus of Example 3 together with its usage environment.

### DESCRIPTION OF EMBODIMENTS

Hereinafter, embodiments of the present invention will be described with reference to the accompanying drawings. In all the drawings, like elements are referenced by like reference numerals and descriptions thereof will not be repeated.

### Embodiment 1

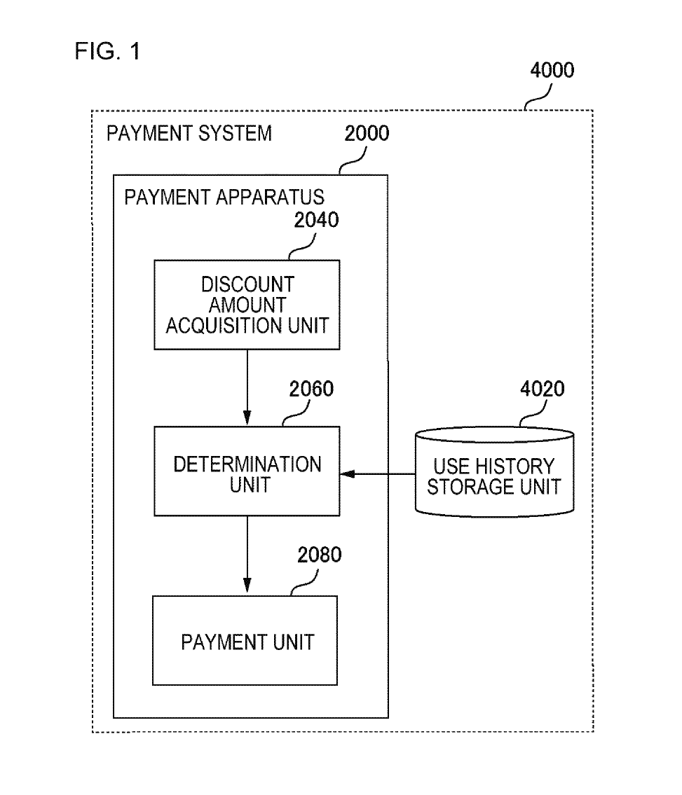

FIG. 1 is a block diagram illustrating a payment system 4000 according to Embodiment 1. In FIG. 1, arrows indicate a flow of information. Further, in FIG. 1, each block represents a function-based block rather than a hardware-based configuration.

The payment system 4000 includes a payment apparatus 2000 and a use history storage unit 4020. The payment system 4000 is a system that performs payment using a target electronic money card (hereinafter, target card). The payment apparatus 2000 includes a discount amount acquisition unit 2040, a determination unit 2060, and a payment unit 2080. Hereinafter, a detailed description will be given.

<Discount Amount Acquisition Unit 2040>

The discount amount acquisition unit 2040 acquires a discount amount. There are various methods with which the discount amount acquisition unit 2040 acquires a discount amount. For example, the discount amount acquisition unit 2040 acquires a discount amount being input from an external apparatus. Furthermore, for example, the discount amount acquisition unit 2040 acquires a discount amount being manually input. Further, the discount amount acquisition unit 2040 may have access to an external apparatus in order to acquire a discount amount.

<Determination Unit 2060>

The determination unit 2060 determines whether or not a discount is to be applied to the purchase price of a product, on the basis of the use history of the target card. To do so, the determination unit 2060 acquires information regarding the use history of the target card from the use history storage unit 4020. Note that, the term “product” as used herein is assumed to include a service. Therefore, the purchase amount of a product also includes the usage fee of a service.

<Payment Unit 2080>

In a case where the determination unit 2060 determines a discount is to be applied, the payment unit 2080 applies a discount to the purchase price of the product on the basis of the discount amount, and performs payment by card using the target card. Here, the payment by card means that the payment of product purchase is performed using electronic money that is associated with the target card. Suppose that the payment of 200 yen is required when the purchase amount is 500 yen as a result of applying a discount on the basis of the discount amount. In this case, the payment unit 2080 performs a payment process of paying 200 yen using electronic money that is associated with the target card.

In order to perform payment by card, there is a need for a process of acquiring information regarding the electronic money that is associated with the target card. For example, this process is performed using a card reader or the like that reads an electronic money card. This process may be performed by the payment apparatus 2000, or may be performed by another apparatus different from the payment apparatus 2000. In a case where this process is performed by an apparatus different from the payment apparatus 2000, the payment unit 2080 acquires information regarding the electronic money that is associated with the target card from this apparatus.

Similarly, in order to perform payment by card, it is required to be able to reflect the result of payment by card in the electronic money that is associated with the target card. For example, this process is performed by a card writer or the like that writes information in an electronic money card. This process may be performed by the payment apparatus 2000, or may be performed by another apparatus different from the payment apparatus 2000. In a case where this process is performed by an apparatus different from the payment apparatus 2000, the payment unit 2080 transmits information regarding payment to this apparatus.

A payment process using an electronic money card is a well-known technique, and thus any further detailed description of the payment process using an electronic money card will not be described.

<Use History Storage Unit 4020>

The use history storage unit 4020 stores the use history of the target card. The use history of the target card is a history of payment by card using the target card, a history of depositing performed on the target card, or the like.

The use history storage unit 4020 may be included inside the payment apparatus 2000, or may be included outside the payment apparatus 2000. For example, the use history storage unit 4020 is included inside the target card. The storage of the use history in the use history storage unit 4020 may be performed by the payment apparatus 2000, and may be performed by an apparatus other than the payment apparatus 2000.

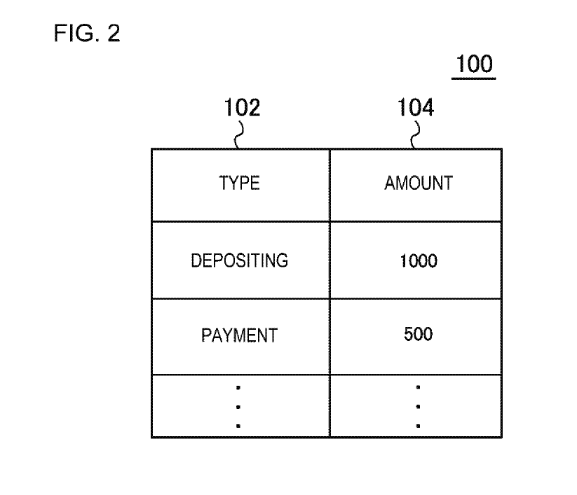

FIG. 2 is a diagram illustrating a use history stored in the use history storage unit 4020 in a table form. The table shown in FIG. 2 is described as a use history table 100. The use history table 100 includes a type 102 and an amount 104. The type 102 indicates the type of use history, such as payment or depositing. For example, a record of a first row in FIG. 2 indicates that the depositing of 1000 yen is performed on the target card. In addition, for example, a record of a second row in FIG. 2 indicates that payment by card of 500 yen is performed using the target card.

Note that, in a case where the use history storage unit 4020 stores use histories relating to a plurality of electronic money cards, each record of the use history table 100, for example, further indicates an ID of the electronic money card.

### ADVANTAGEOUS EFFECTS

According to the present embodiment, it is possible to apply a discount to the purchase price of a product on the basis of the discount amount. Therefore, it is achieved to reduce the burden of a user who purchases an electronic money card by determining the discount amount in consideration of the purchase amount of the electronic money card. As a result, it is achieved to improve the widespread use rate of an electronic money card.

Note that, in a case where it is intended to reduce the burden of a user who purchases an electronic money card, it is proper to apply a discount by setting the purchase amount of the electronic money card to an upper limit. In the present embodiment, when the payment unit 2080 applies a discount by setting the purchase amount of the electronic money card to an upper limit, it is able to avoid applying an excessive discount while reducing the burden of a user who purchases the electronic money card, and thus it is achieved to apply an appropriate discount.

Further, according to the present embodiment, whether or not the purchase price of a product is discounted is determined on the basis of the use history of the target card. Therefore, when an apparatus or the like that manages the use history of the target card has already been in operation, the payment system 4000 can be constructed leveraging this use history. Therefore, according to the present embodiment, it is achieved to easily realize the payment system 4000 that applies an appropriate discount, without newly introducing a system or the like that manages a history of discounts applied to the purchase price.

<Hardware Configuration>

Each functional configuration unit included in the payment apparatus 2000 is realized by, for example, at least one hardware component in a state where individual or a plurality of units are combined. Furthermore, for example, each functional configuration unit may be realized by at least one software component. Furthermore, for example, each functional configuration unit may be realized by a combination of hardware components and software components.

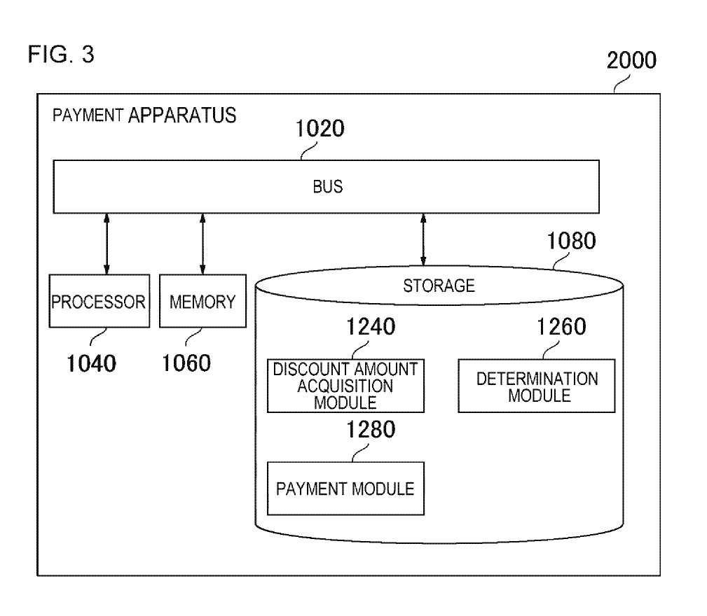

FIG. 3 is a block diagram illustrating a hardware configuration of the payment apparatus 2000. The payment apparatus 2000 of FIG. 3 is a form of computers, and includes a bus 1020, a processor 1040, a memory 1060, and storage 1080.

The bus 1020 is a data transmission channel in order for the processor 1040, the memory 1060, and the storage 1080 to mutually transmit and receive data. The processor 1040 is an arithmetic processing unit such as, for example, a central processing unit (CPU) or a graphics processing unit (GPU). The memory 1060 is a memory such as, for example, a random access memory (RAM) or a read only memory (ROM). The storage 1080 is a storage apparatus such as, for example, a hard disk, a solid state drive (SSD), or a memory card. In addition, the storage 1080 may be a memory such as a RAM or a ROM.

A discount amount acquisition module 1240 is a program for causing the payment apparatus 2000 to have a function of the discount amount acquisition unit 2040. The processor 1040 realizes the function of the discount amount acquisition unit 2040 by executing the discount amount acquisition module 1240.

A determination module 1260 is a program for causing the payment apparatus 2000 to have a function of the determination unit 2060. The processor 1040 realizes the function of the determination unit 2060 by executing the determination module 1260.

A payment module 1280 is a program for causing the payment apparatus 2000 to have a function of the payment unit 2080. The processor 1040 realizes the function of the payment unit 2080 by executing the payment module 1280.

For example, the processor 1040 reads out and executes the respective modules on the memory 1060. However, the processor 1040 may execute the respective modules without reading out the modules on the memory 1060.

The storage 1080 stores the respective modules.

The hardware configuration of the payment apparatus 2000 is not limited to the configuration shown in FIG. 3. For example, the respective modules may be stored in the memory 1060. In this case, the payment apparatus 2000 may not include the storage 1080.

<Flow of Processes>

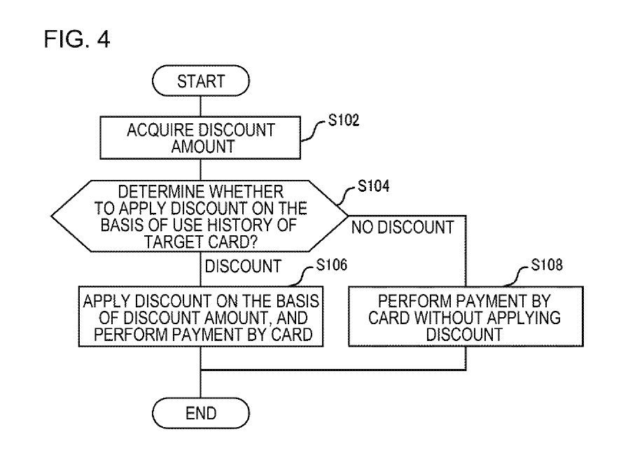

FIG. 4 is a flow diagram illustrating a flow of processes executed by the payment apparatus 2000 of Embodiment 1. In step S102, the discount amount acquisition unit 2040 acquires a discount amount.

In step S104, the determination unit 2060 determines whether or not a discount is to be applied to the purchase price of a product on the basis of the use history of the target card. In a case where it is determined that a discount is to be applied in step S104, the process of FIG. 4 proceeds to step S106. On the other hand, in a case where it is determined that a discount is not to be applied in step S104, the process of FIG. 4 proceeds to step S108.

In step S106, the payment unit 2080 applies a discount to the purchase price of a product on the basis of the discount amount, and performs payment by card using the target card. On the other hand, in step S108, the payment unit 2080 performs payment by card using the target card without applying a discount to the purchase price of a product.

### Embodiment 2

A payment system 4000 of Embodiment 2 is shown in FIG. 1 similarly to the payment system 4000 of Embodiment 1. The payment system 4000 of Embodiment 2 is the same as the payment system 4000 of Embodiment 1, except for the matters described below.

A determination unit 2060 of Embodiment 2 determines whether or not the target card has been used in payment by card. In a case where the target card has never been used in payment by card, the determination unit 2060 determines a discount is to be applied.

According to the present embodiment, it is achieved to apply a discount to the purchase price when payment by card is performed for the first time using the target card. In this manner, it achieved to avoid applying an excessive discount on the purchase price of a product while reducing a user's burden of the card purchase price.

There are various methods with which the determination unit 2060 determines “whether or not the target card has been used in payment by card”. Hereinafter, two of the determination methods will be illustrated.

<Determination Method 1>

In a case where a use history indicating payment by card is not stored in the use history storage unit 4020, the determination unit 2060 determines that “the target card has never been used in payment by card”.

There are various methods with which the determination unit 2060 determines “whether a use history indicating payment by card is stored in a use history acquisition unit 2020”. For example, the determination unit 2060 acquires all the use histories of the target card from the use history storage unit 4020. In a case where the number of items of the use history being acquired is 0, it is determined that “the target card has never been used in payment by card”. In a case where the use history can be acquired, the determination unit 2060 inspects the type of each use history being acquired. Here, the type of use history of the target card may include not only “payment” but also “depositing” in the target card, or the like. In a case where the number of items of the use history, the type of which is “payment”, is 0, the determination unit 2060 determines that “the target card has never been used in payment by card”.

Note that, initial depositing in the target card may necessarily have to be performed due to the specification of the target card or the utilization of the target card. In this case, the first record of use history necessarily indicates a history of “depositing”. Therefore, in this case, the determination unit 2060 determines that “the target card has never been used in payment by card” in a case where the number of items of the use history of the target card is equal to or less than one.

In addition, for example, in a case where the use history storage unit 4020 is realized by a database or the like for receiving a search of the use history, the determination unit 2060 may inquire the number of items of the use history indicating payment by card of the target card, from the use history storage unit 4020. In this case, when the number of items of the inquiry result is 0, the determination unit 2060 determines that “the target card has never been used in payment by card”.

<Determination Method 2>

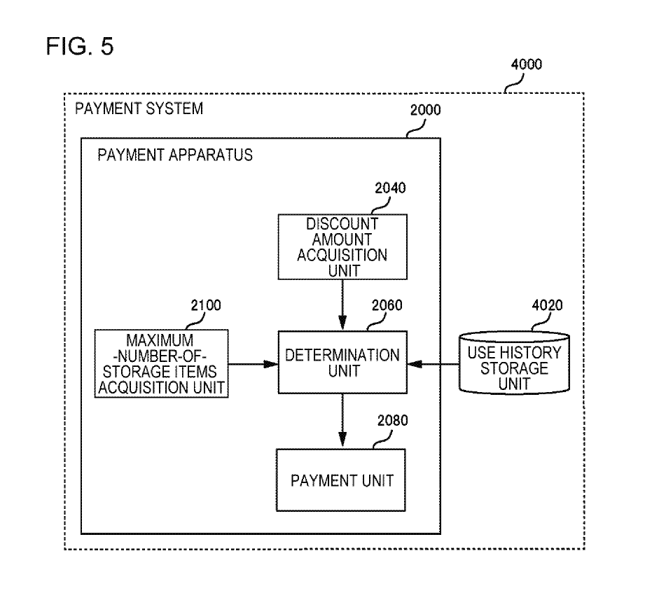

The determination unit 2060 determines whether or not the target card has been used in payment by card, as follows. Here, in a case where a determination is performed using the following method, the payment apparatus 2000 includes a maximum-number-of-storage items acquisition unit 2100. The maximum-number-of-storage items acquisition unit 2100 acquires the maximum number of storage items of the use history capable of being stored in the use history storage unit 4020. FIG. 5 is a block diagram illustrating a payment apparatus 2000 of Embodiment 2 including the maximum-number-of-storage items acquisition unit 2100. Note that, there are various methods with which the maximum-number-of-storage items acquisition unit 2100 acquires the maximum number of storage items. For example, the maximum-number-of-storage items acquisition unit 2100 acquires the maximum number of storage items being input from an external apparatus. Furthermore, for example, the maximum-number-of-storage items acquisition unit 2100 acquires the maximum number of storage items being manually input. Further, the maximum-number-of-storage items acquisition unit 2100 may have access to an external apparatus to acquire the maximum number of storage items.

The determination unit 2060 determines whether the use history indicating payment by card is stored in the use history storage unit 4020. In addition, the determination unit 2060 determines whether or not the number of items of the use history is less than the maximum number of storage items. The determination unit 2060 determines that “the target card has never been used in payment by card” in a case where the use history indicating payment by card is not present and the number of items of the use history is less than the maximum number of storage items.

For example, the determination unit 2060 acquires all the use histories of the target card from the use history storage unit 4020, to thereby ascertain the number of items of the use history. In addition, for example, in a case where the use history storage unit 4020 is realized by a database or the like for receiving a search of the use history, the determination unit 2060 may inquire the number of items of the use history of the target card, from the use history storage unit 4020.

In a case where the number of items of the use history stored in the use history storage unit 4020 is equal to or greater than the maximum number of storage items, a past use history could be deleted as a result of that the use history storage unit 4020 becomes not capable of storing the use history. In addition, the deleted use history could be a history of payment by card using target card. Thus, in a case where the number of items of the use history stored in the use history storage unit 4020 is equal to or greater than the maximum number of storage items, it is difficult to determine whether or not the target card has been used in payment by card, simply using information stored in the use history storage unit 4020.

On the other hand, in a case where the number of items of the use history stored in the use history storage unit 4020 is less than the maximum number of storage items, it is considered that a situation does not occur in which “a past use history is deleted as a result of that the use history storage unit 4020 becomes not capable of storing the use history”. Therefore, when the history of payment by card using the target card is not stored in the use history storage unit 4020, it can be determined that payment by card using the target card is not performed.

Thus, the determination unit 2060 determines that “the target card has never been used in payment by card”, in a case where the use history indicating payment by card is not stored in the use history storage unit 4020 and the number of items of the use history stored in the use history storage unit 4020 is less than the maximum number of storage items. In this manner, it is possible to apply a discount to payment using the target card in a case where it can be reliably ascertained that “the target card has never been used in payment by card”. Thus, it is achieved to avoid applying an excessive discount in a situation where “the target card has already been used in payment by card, but the history of payment by card has been deleted due to a shortage in the capacity of the use history storage unit 4020”.

Here, since the maximum number of storage items is arbitrary in the configuration of the present embodiment, the payment system 4000 of the present embodiment normally operates even in a case where the maximum number of storage items is small. Thus, the payment apparatus 2000 can correctly operate even in a case where the number of items of the use history capable of being acquired is small.

<Flow of Processes>

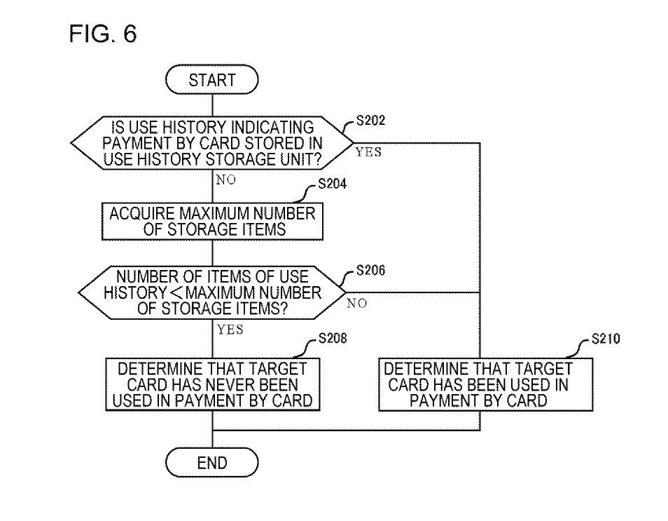

FIG. 6 is a flow diagram illustrating a flow of processes in a case where the determination unit 2060 performs a determination in a determination method 2. In step S202, the determination unit 2060 determines whether or not the use history indicating payment by card is stored in the use history storage unit 4020. In a case where the use history indicating payment by card is not stored in the use history storage unit 4020 (step S202: NO), the process of FIG. 6 proceeds to step S204. On the other hand, in a case where the use history indicating payment by card is stored in the use history storage unit 4020 (step S202: YES), the process of FIG. 6 proceeds to step S210.

In step S204, the maximum-number-of-storage items acquisition unit 2100 acquires the maximum number of storage items of the use history capable of being stored in the use history storage unit 4020. In step S206, the determination unit 2060 determines whether or not the number of items of the use history is less than the maximum number of storage items. In a case where the number of items of the use history is less than the maximum number of storage items (step S206: YES), the process of FIG. 6 proceeds to step S208. On the other hand, in a case where the number of items of the use history is equal to or greater than the maximum number of storage items (step S206: NO), the process of FIG. 6 proceeds to step S210.

In step S208, the determination unit 2060 determines that “the target card has never been used in payment by card”. On the other hand, in step S210, the determination unit 2060 determines that “the target card has been used in payment by card”.

### Embodiment 3

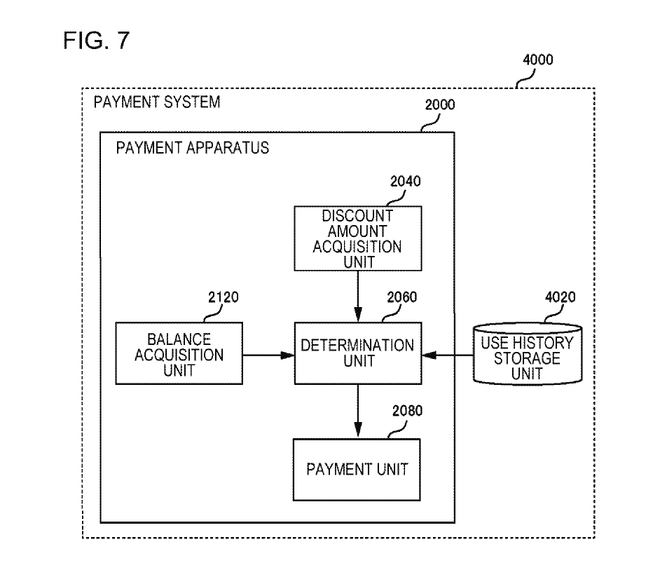

FIG. 7 is a block diagram illustrating a payment system 4000 of Embodiment 3. In FIG. 7, arrows indicate a flow of information. Further, in FIG. 7, each block represents a function-based block rather than a hardware-based configuration.

A determination unit 2060 of Embodiment 3 determines to apply a discount in a case where the total amount of discounts having been applied so far to the purchase of products using the target card is smaller than a discount amount acquired by the discount amount acquisition unit 2040. Hereinafter, a detailed description will be given. Note that, in the following description, “the total amount of discounts having been applied so far to the purchase of products using the target card” is described as a total discount value.

A payment apparatus 2000 of Embodiment 3 includes a balance acquisition unit 2120. The balance acquisition unit 2120 acquires a balance of the target card. Here, the balance of the target card means electronic money associated with the target card.

There are various methods with which the balance acquisition unit 2120 acquires the balance of the target card. For example, the balance acquisition unit 2120 acquires the balance of the target card being input from the external apparatus. Furthermore, for example, the balance acquisition unit 2120 acquires the balance of the target card being manually input. Further, the balance acquisition unit 2120 may have access to an external apparatus to acquire the balance of the target card.

Note that, in a case where the balance of the target card is acquired from an external apparatus, the balance may be information acquired from the target card using a card reader or the like, and may be information acquired from a system or the like that manages the association of the target card with the balance.

The determination unit 2060 determines the total discount value. For example, the determination unit 2060 determines the total discount value using the total value of purchase prices indicated by the use history stored in the use history storage unit 4020, the balance of the target card acquired by the balance acquisition unit 2120, and the total value of depositing amounts for the target card indicated by the use history stored in the use history storage unit 4020.

In a case where the determination unit 2060 determines to apply a discount, a payment unit 2080 of Embodiment 3 discounts from the purchase price an amount equal to or less than a difference between the discount amount acquired by the discount amount acquisition unit 2040 and the total discount value.

There are various amounts that are discounted from the purchase price through a single payment by card by the payment unit 2080. For example, the payment unit 2080 may fixedly set an amount being discounted from the purchase price. The payment unit 2080 discounts from the purchase price the smaller one of: the amount being fixedly set; and the difference between the discount amount acquired by the discount amount acquisition unit 2040 and the total discount value. In addition, for example, the payment unit 2080 may acquire a discount amount from the purchase price every time payment by card is performed. In this case, the payment unit 2080 discounts from the purchase price the smaller one of: the acquired amount; and the difference between the discount amount acquired by the discount amount acquisition unit 2040 and the total discount value.

<Specific Example of Method of Determining Total Discount Value>

For example, the determination unit 2060 determines the total discount value in the following method. Note that, in a case where the total discount value is determined using the method illustrated below, the use history of payment by card stored in the use history storage unit 4020 indicates a purchase price before a discount. For example, in a case where the purchase amount is 500 yen, and where an amount paid as a result of a discount is 200 yen, the use history storage unit 4020 stores the use history indicating the purchase price of “500 yen.”

First, the determination unit 2060 determines a sum of the total value of purchase prices indicated by the use history stored in the use history storage unit 4020 and the balance of the target card acquired by the balance acquisition unit 2120. Next, the determination unit 2060 determines a difference between the determined sum and the total value of depositing amounts for the target card indicated by the use history stored in the use history storage unit 4020. This difference serves as the total discount value.

For example, the determination unit 2060 acquires all the use histories of the target card from the use history storage unit 4020, and extracts a use history indicating payment by card and a use history indicating depositing for the target card, from the acquired use histories. The determination unit 2060 determines the total values of purchase prices by summing the purchase price shown in each use history indicating payment by card. In addition, the determination unit 2060 determines the total value of depositing amounts by summing the depositing amounts shown in each use history indicating depositing for the target card.

In addition, in a case where the use history storage unit 4020 is realized by a database or the like, the determination unit 2060 may search for the use history indicating payment by card of the target card, and search for the use history indicating depositing for the target card.

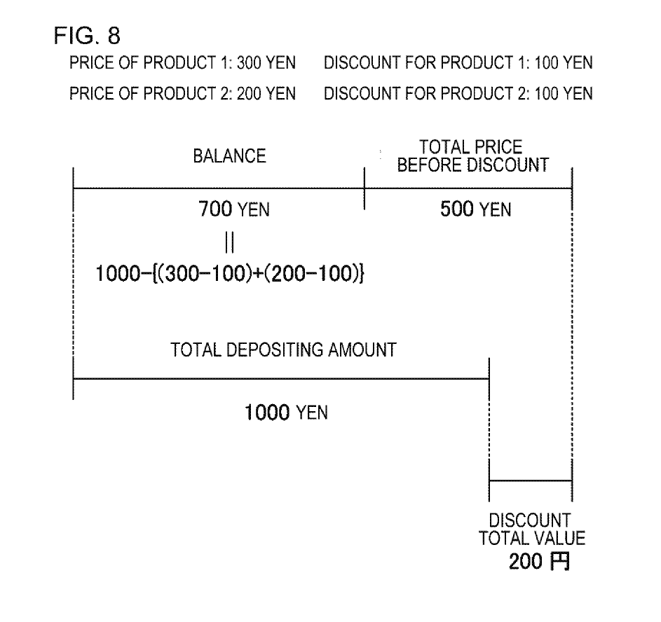

FIG. 8 is a diagram conceptually illustrating a process performed by the determination unit 2060 of Embodiment 3. It is assumed that the total of depositing amounts for the target card is 1000 yen. In addition, it is assumed that a product 1 and a product 2 are purchased using the target card. Here, the price of the product 1 is 300 yen, and the price of the product 2 is 200 yen. In addition, it is assumed that a discount of 100 yen is applied to each of the two products when these two products are purchased. In this case, the total of purchase prices of the product 1 and the product 2 is 300 yen. Thus, after the product 1 and the product 2 are purchased, the balance of the target card is 700 yen. However, since the use history stored in the use history storage unit 4020 indicates purchase prices before a discount (prices of products in the present example), the use histories relating to payment by card of the two products indicate 300 yen and 200 yen, respectively.

Under the following conditions, the determination unit 2060 first determines the total value of purchase prices shown in the use history. This total value is 300 yen+200 yen=500 yen. Next, the determination unit 2060 adds this total value to 700 yen (the balance of the target card of 700 yen), and determines a value of 1200 yen. The determination unit 2060 determines a difference between 1200 yen and 1000 yen (the total of depositing amounts). The result of this calculation is 200 yen.

Using the above calculation, the determination unit 2060 determines the total discount value of 200 yen. In reality, as described above, a discount of 100 yen for each of the two products is applied, and thus the total value of discounts is 200 yen.

Note that, the orders of calculation performed by the determination unit 2060 may be changed as long as a similar result is obtained. For example, it is also possible to obtain a similar result by adding the total value of purchase prices before a discount to a value obtained by subtracting the total value of depositing amounts from the balance of the target card.

<Flow of Processes>

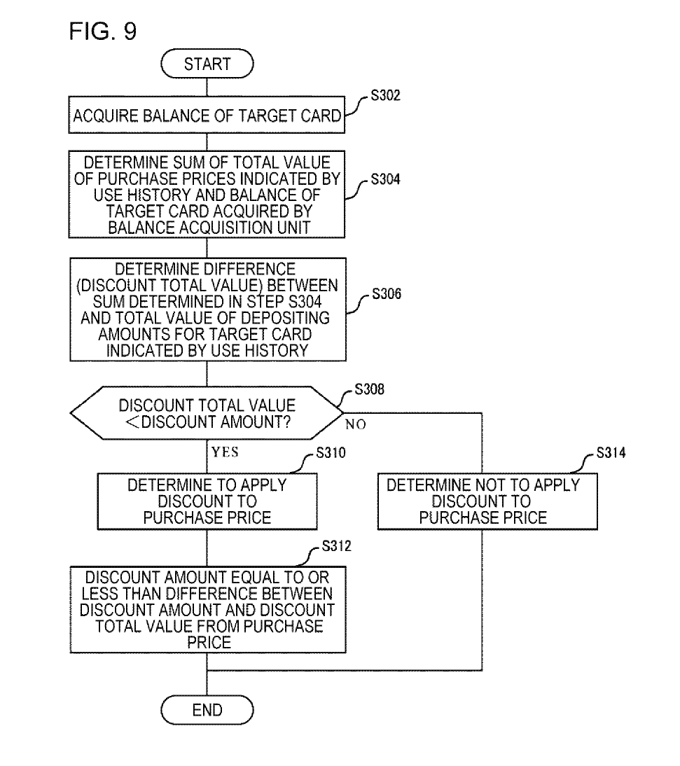

FIG. 9 is a flow diagram illustrating a flow of processes executed by the payment apparatus 2000 of Embodiment 3. In step S302, the balance acquisition unit 2120 acquires the balance of the target card. In step S304, the determination unit 2060 determines a sum of the total value of purchase prices indicated by the use history and the balance of the target card acquired by the balance acquisition unit 2120. In step S306, the determination unit 2060 determines a difference (total discount value) between the sum determined in step S304 and the total value of depositing amounts for the target card indicated by the use history.

In step S308, the determination unit 2060 determines whether or not the total discount value is less than the discount amount acquired by the discount amount acquisition unit 2040. In a case where the total discount value is less than the discount amount (step S308: YES), the process of FIG. 9 proceeds to step S310. On the other hand, in a case where the total discount value is equal to or greater than the discount amount (step S308: NO), the process of FIG. 9 proceeds to step S314.

In step S310, the determination unit 2060 determines to apply a discount to the purchase price. In step S312, the payment unit 2080 discounts an amount equal to or less than a difference between the discount amount and the total discount value from the purchase price.

On the other hand, in step S314, the determination unit 2060 determines not to apply a discount to the purchase price.

### Advantageous Effects

According to the payment system 4000 of the present embodiment, it is possible to apply multiple discounts in payment using the target card, unlike the payment system 4000 of Embodiment 2. For example, the payment system 4000 of the present embodiment is suitable for a case where the price of a product to be purchased is smaller than a desired amount of discount (for example, purchase amount of the target card). For example, in a case where the purchase amount of the target card is 500 yen, it is assumed that the purchase price in initial payment by card using the target card is 200 yen. In this case, only 200 yen, which is a portion of the purchase amount, can be given back to a user with a method of “applying a discount only in initial payment by card”.

On the other hand, according to the present embodiment, the maximum value of the amounts of discounts applied to the target card is determined in consideration of the total amount of discounts having been applied so far to the target card. Therefore, it is possible to execute multiple discounts for the purchase of products using the target card, and to set the total value of amounts discounted by the multiple discounts to be equal to or less than the discount amount acquired by the discount amount acquisition unit 2040. Thus, it is achieved to reduce a burden of a user who purchases the target card through discounts for multiple payments by card.

In addition, according to the payment system 4000 of the present embodiment, it is not necessary to store a history relating to a discount applied to the purchase of a product using the target card. Therefore, it is possible to execute multiple discounts for the purchase of products using the target card in the payment system 4000, without changing the specification (for example, specification of the target card) of the payment system 4000 (for example, specification of the target card) that is in operation.

### Modification Example 3-1

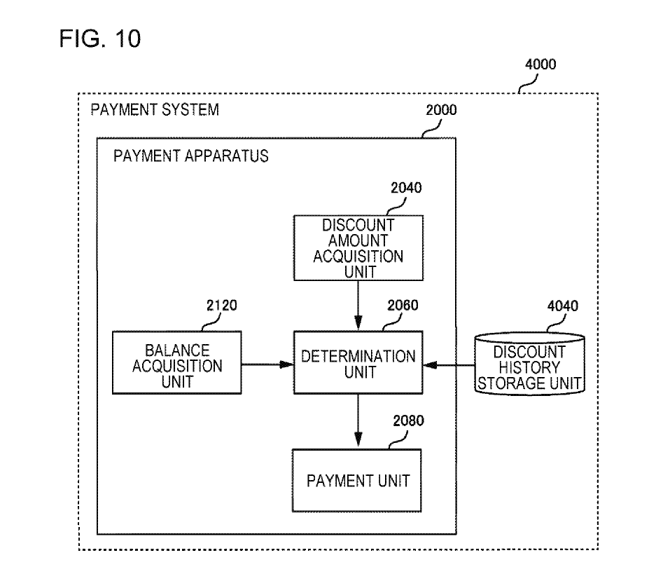

The payment system 4000 may include a configuration represented by a block diagram shown in FIG. 10. Hereinafter, such an embodiment is described as Modification Example 3-1.

The payment system 4000 of Modification Example 3-1 includes a discount history storage unit 4040. The discount history storage unit 4040 stores a history of discounts applied to the purchase of a product using the target card. A determination unit 2060 of Modification Example 3-1 determines a total discount value by acquiring the history of discounts from the discount history storage unit 4040. In a case where the total discount value is less than the discount amount acquired by the discount amount acquisition unit 2040, the determination unit 2060 determines to apply a discount to the purchase of a product using the target card. In this case, a payment unit 2080 of Modification Example 3-1 sets a difference between the discount amount and the total discount value to the upper-limit amount of a discount.

Here, the discount history storage unit 4040 may individually store a discounted amount for each of the discounts, or may store the total value of the discounted amounts in each of the discounts (equivalent to the aforementioned total discount value). In a case where the histories are individually stored, the determination unit 2060 determines the total discount value by determining the total value of the amounts that are individually stored.

The discount history storage unit 4040 may be provided inside the payment apparatus 2000, or may be provided outside the payment apparatus 2000. In a case where the discount history storage unit 4040 of the payment apparatus 2000 is provided outside, the discount history storage unit 4040 is provided, for example, in the target card, in a server apparatus, or the like. The storage of the history in the discount history storage unit 4040 may be performed by the payment apparatus 2000, or may be performed by an apparatus other than the payment apparatus 2000.

According to the present modification example, the payment system 4000 can easily ascertain the amounts of discounts that have been applied so far to the purchase of products using the target card by acquiring the history stored in the discount history storage unit 4040. Therefore, according to the present modification example, in a case where multiple discounts are applied to the purchase of products using the target card, there is an advantage that a time required for the determination process performed by the determination unit 2060 is short.

### Embodiment 4

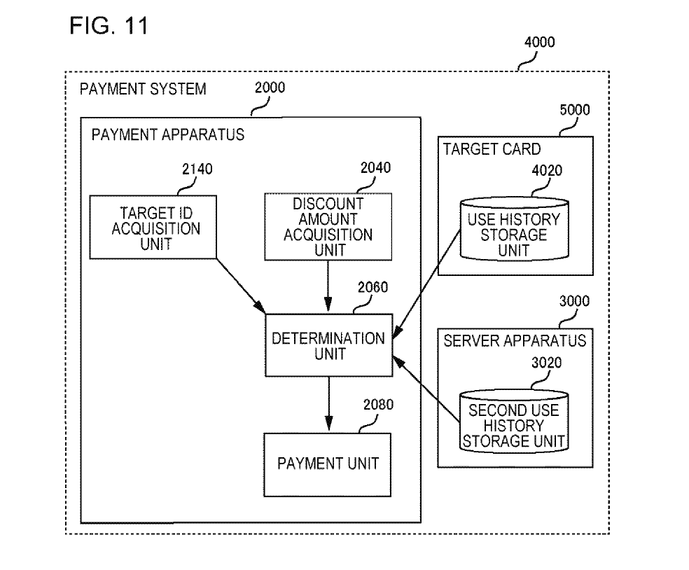

FIG. 11 is a block diagram illustrating a payment system 4000 of Embodiment 4. In FIG. 11, arrows indicate a flow of information. Further, in FIG. 11, each block represents a function-based block rather than a hardware-based configuration.

A payment system 4000 of Embodiment 4 includes a payment apparatus 2000, a server apparatus 3000, and a target card 5000. Except for the following points described below, the payment apparatus 2000 of Embodiment 4 has the same function as that of the payment apparatus 2000 of Embodiment 1.

<Target Card 5000>

In the payment system 4000 of Embodiment 4, a use history storage unit 4020 is included inside the target card 5000. For example, the use history storage unit 4020 is realized by an IC chip or the like, and is embedded inside the target card 5000. However, a method of realizing the use history storage unit 4020 is not limited to the IC chip.

<Payment Apparatus 2000>

The payment apparatus 2000 of Embodiment 4 includes a target ID acquisition unit 2140. The target ID acquisition unit 2140 acquires a target ID. For example, the target ID is a user ID or a card ID of the target card.

There are various methods with which the target ID acquisition unit 2140 acquires the target ID. For example, the target ID acquisition unit 2140 acquires a target ID being manually input. In addition, for example, the target ID acquisition unit 2140 acquires a target ID being input from an external apparatus. Further, the target ID acquisition unit 2140 may access to an external apparatus to acquire a target ID. The external apparatus is, for example, a card reader or the like that acquires information from the target card.

A determination unit 2060 of Embodiment 4 determines whether or not to apply a discount to the purchase price on the basis of a use history stored in the use history storage unit 4020 and a use history stored in a second use history storage unit 3020. Therefore, the determination unit 2060 acquires information regarding the use history from each of the use history storage unit 4020 and the second use history storage unit 3020.

<Server Apparatus 3000>

The server apparatus 3000 is communicably connected to the payment apparatus 2000. The payment apparatus 2000 and the server apparatus 3000 may be connected to each other through a wired line, may be connected to each other through a wireless line, or may be connected to each other through a communication line in which a wired line and a wireless line are mixed.

The server apparatus 3000 includes a second use history storage unit 3020. The second use history storage unit 3020 stores the use history of the target card 5000 in association with the target ID. Note that, the second use history storage unit 3020 stores both of the use history that has been stored in the use history storage unit 4020 and the use history that has already been deleted from the use history storage unit 4020.

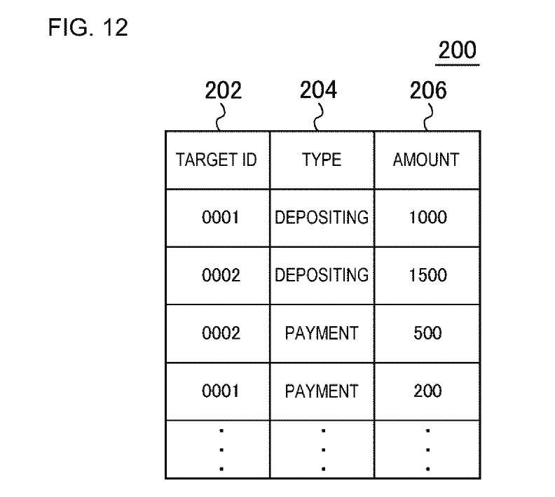

FIG. 12 is a diagram illustrating a use history stored in the second use history storage unit 3020 in a table form. The table shown in FIG. 12 is described as a second use history table 200. The second use history table 200 includes three columns of a target ID 202, a type 204 and an amount 206. Similarly to the type 102 and the amount 104 of FIG. 2, the type 204 and the amount 206 indicate the use history of the target card 5000. Each record of the second use history table 200 indicates the type 204 and the amount 206 (use history) in association with the target ID 202.

Note that, the second use history storage unit 3020 may store a use history with respect to one target ID, or may store a use history with respect to each of a plurality of targets ID. In a case of FIG. 12, the second use history storage unit 3020 stores a use history with respect to each of a plurality of targets ID (0001 and 0002).

A function of writing a use history into second use history storage unit 3020 may be provided inside or outside the payment apparatus 2000. A functional configuration unit having a function of writing a use history into the second use history storage unit 3020 is described as a second use history writing unit. The second use history writing unit may write a use history into the second use history storage unit 3020 at a point in time when the target card is used, or may write the use history at a separate timing. For example, the second use history writing unit temporarily writes the use history of the target card into the inside of the payment apparatus 2000 or the like, and collectively writes a plurality of use histories into the second use history storage unit 3020 at a later point in time. In this manner, a process of collectively writing information at a later point in time is also called a batch process.

Note that, the use history indicating payment by card stored in the second use history storage unit 3020 may be further associated with a product ID of a product that is a target for payment by card. In this case, for example, the determination unit 2060 uses a use history an associated product ID of which is a predetermined ID, among the use histories stored in the second use history storage unit 3020.

The predetermined ID is, for example, set in the payment apparatus 2000 in advance. Furthermore, for example, the payment apparatus 2000 may have a function of acquiring the predetermined ID. There are various methods with which the payment apparatus 2000 acquires the predetermined ID, similarly to the methods with which the target ID acquisition unit 2140 acquires the target ID.

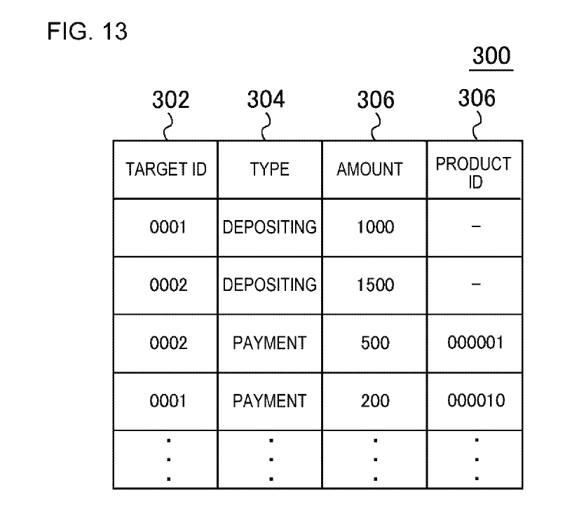

FIG. 13 is a diagram illustrating a use history in association with the product ID, which is stored in the second use history storage unit 3020 in a table form. The table shown in FIG. 13 is described as a second use history table 300. The second use history table 300 includes a target ID 302, a type 304, an amount 306, and a product ID 308.

<Flow of Processes>

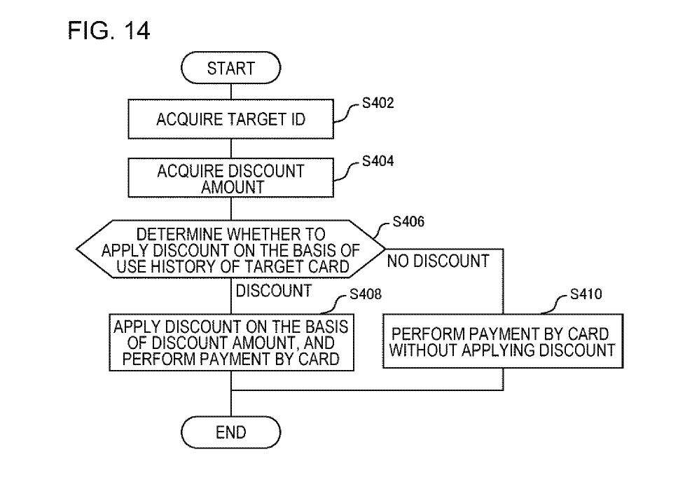

FIG. 14 is a flow diagram illustrating a flow of processes executed by the payment apparatus 2000 of Embodiment 4. In step S402, the target ID acquisition unit 2140 acquires a target ID. In step S404, the discount amount acquisition unit 2040 acquires a discount amount.

In step S406, the determination unit 2060 determines whether or not to apply a discount to the purchase price of a product, on the basis of the use history of the target card. In a case where it is determined in step S406 to apply a discount, the process of FIG. 14 proceeds to step S408. On the other hand, in a case where it is determined in step S406 not to apply a discount, the process of FIG. 14 proceeds to step S410.

In step S408, the payment unit 2080 applies a discount to the purchase price of a product on the basis of the discount amount, and performs payment by card using the target card. On the other hand, in step S410, the payment unit 2080 performs payment by card using the target card without applying a discount to the purchase price of a product.

### Advantageous Effects

According to the present embodiment, the use history stored in the second use history storage unit 3020 is further used to determine whether or not to apply a discount to the purchase price in payment by card using the target card. Here, since the use history of the target card 5000 is stored not only in the use history storage unit 4020 but also in the second use history storage unit 3020, it is achieved to reduce the capacity of the use history storage unit 4020.

In addition, since the capability to reduce the capacity of the use history storage unit 4020 makes it possible to cut the price of the target card 5000, it is achieved to further reduce the burden of a user who purchases the target card 5000.

In addition, as described above, the payment apparatus 2000 of the present embodiment may determines whether or not to apply a discount to the purchase price, using the use history the associated product ID of which is the predetermined ID. This makes it possible to perform an operation such as that “a discount is applied in a case where a predetermined product has not yet been purchased” or the like.

### Embodiment 5

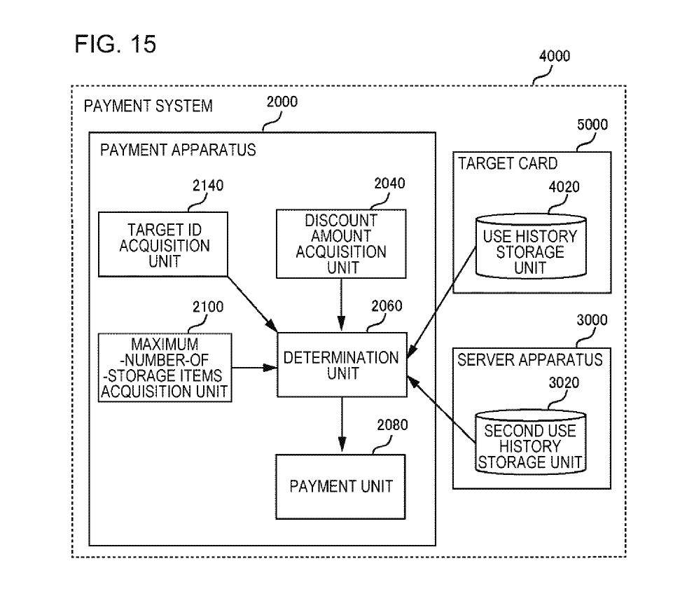

FIG. 15 is a block diagram illustrating a payment system 4000 of Embodiment 5. In FIG. 15, arrows indicate a flow of information. Further, in FIG. 15, each block represents a function-based block rather than a hardware-based configuration. Except for the following points described below, the payment system 4000 of Embodiment 5 is the same as the payment system 4000 of Embodiment 4.

A payment apparatus 2000 of Embodiment 5 includes a maximum-number-of-storage items acquisition unit 2100. The maximum-number-of-storage items acquisition unit 2100 has the same function as that of the maximum-number-of-storage items acquisition unit 2100 included in the payment apparatus 2000 of Embodiment 2.

A determination unit 2060 of Embodiment 5 determines whether or not to apply a discount to the purchase price, as follows. First, the determination unit 2060 determines whether or not the number of items of a use history stored in a use history storage unit 4020 equals to the maximum number of storage items of the use history storage unit 4020. In a case where the number of items of the use history stored in the use history storage unit 4020 equals to the maximum number of storage items of the use history storage unit 4020, the determination unit 2060 determines whether or not a use history associated with the target ID is stored in a second use history storage unit 3020 when a use history indicating payment by card is not stored in the use history storage unit 4020. The determination unit 2060 determines to apply a discount to the purchase price when the second use history storage unit 3020 does not store the use history being associated with the target ID and indicating payment by card.

In a case where the number of items of the use history stored in the use history storage unit 4020 is less than the maximum number of storage items of the use history storage unit 4020, for example, the determination unit 2060 determines whether or not to apply a discount to the purchase price, using the same method as that in the determination unit 2060 of Embodiment 2.

For example, in a case where the second use history storage unit 3020 is realized by a database or the like, the determination unit 2060 inquires from the second use history storage unit 3020 using a combination of “target ID=target ID acquired by a target ID acquisition unit 2140, and type=payment” as a key. In a case where the number of inquiry results is 0, the second use history storage unit 3020 determines that the second use history storage unit 3020 does not store the use history being associated with the target ID and indicating payment by card. In addition, for example, the determination unit 2060 may acquire all the use histories from the second use history storage unit 3020, and inspect whether or not a use history that satisfies “target ID=target ID acquired by the target ID acquisition unit 2140, and type=payment” is included the acquired use histories.

<Flow of Processes>

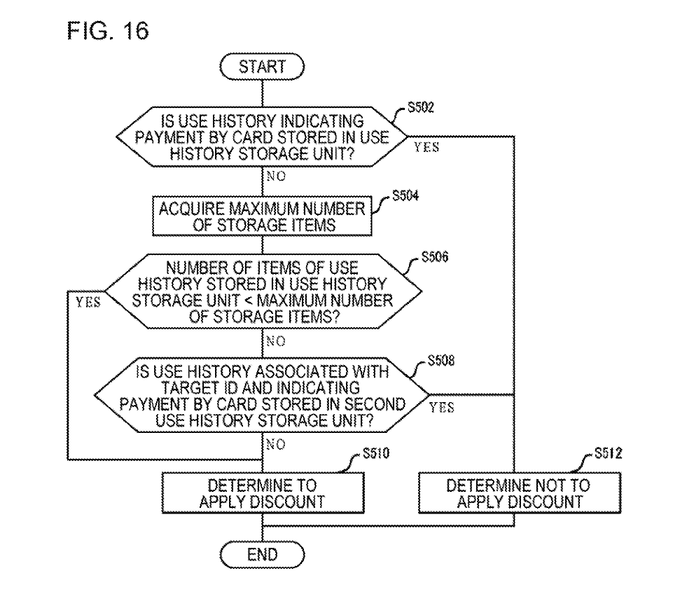

FIG. 16 is a flow diagram illustrating a flow of processes executed by the payment apparatus 2000 of Embodiment 5. In step S502, the determination unit 2060 determines whether or not the use history indicating payment by card is stored in the use history storage unit 4020. In a case where the use history indicating payment by card is not stored (step S502: NO), the process of FIG. 16 proceeds to step S504. On the other hand, in a case where the use history indicating payment by card is stored (step S502: YES), the process of FIG. 16 proceeds to step S512.

In step S504, the maximum-number-of-storage items acquisition unit 2100 acquires the maximum number of storage items of the use history capable of being stored in the use history storage unit 4020. In step S506, the determination unit 2060 determines whether or not the number of items of the use history stored in the use history storage unit 4020 is less than the maximum number of storage items (does not equal to the maximum number of storage items). In a case where the number of items of the use history is not less than the maximum number of storage items (step S506: NO), the process of FIG. 16 proceeds to step S508. On the other hand, in a case where the number of items of the use history is less than the maximum number of storage items (step S506: YES), the process of FIG. 16 proceeds to step S510.

In step S508, the determination unit 2060 determines whether or not the second use history storage unit 3020 stores the use history being associated with the target ID and indicating payment by card. In a case where the second use history storage unit 3020 does not store the use history being associated with the target ID and indicating payment by card (step S508: NO), the process of FIG. 16 proceeds to step S510. On the other hand, in a case where the second use history storage unit 3020 store the use history being associated with the target ID and indicating payment by card (step S508: YES), the process of FIG. 16 proceeds to step S512.

In step S510, the determination unit 2060 determines to apply a discount to the purchase price. On the other hand, in step S512, the determination unit 2060 determines not to apply a discount to the purchase price.

### Advantageous Effects

As described in the determination method 2 described in Embodiment 2, in a case where the number of items of the use history stored in the use history storage unit 4020 is equal to or greater than the maximum number of storage items, the past use history could be deleted as the result of that the use history storage unit 4020 becomes not capable of storing the use history. Thus, it has been described that, in a case where the number of items of the use history stored in the use history storage unit 4020 is equal to or greater than the maximum number of storage items, it is difficult to determine whether or not the target card has been used in payment by card, simply using information stored in the use history storage unit 4020.

On the other hand, in a case where the number of items of the use history stored in the use history storage unit 4020 reaches the maximum number of storage items, the determination unit 2060 of the present embodiment performs the determination further using the use history stored in the second use history storage unit 3020. Therefore, even in a case where there is a use history having been deleted from the use history storage unit 4020, it is possible to determine whether or not the target card 5000 has been used in payment by card. Thus, it is achieved to more appropriately apply a discount to the purchase price in payment by card using the target card 5000.

### Embodiment 6

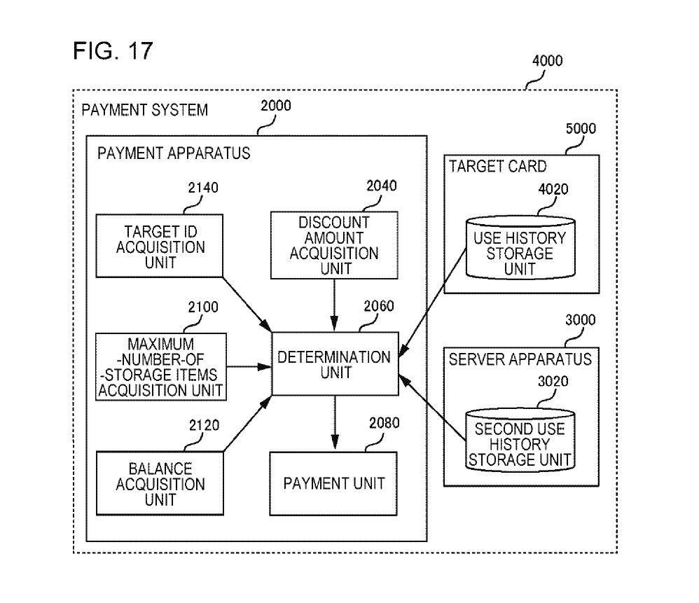

FIG. 17 is a block diagram illustrating a payment system 4000 of Embodiment 6. In FIG. 17, arrows indicate a flow of information. Further, in FIG. 17, each block represents a function-based block rather than a hardware-based configuration.

Similarly to the determination unit 2060 of Embodiment 3, a determination unit 2060 of Embodiment 6 determines to apply a discount in a case where the total discount value (the total amount of discounts that have been applied so far to the purchase of products using the target card) is smaller than a discount amount that is acquired by a discount amount acquisition unit 2040. Hereinafter, a detailed description will be given.

Similarly to the payment apparatus 2000 of Embodiment 5, a payment apparatus 2000 of Embodiment 6 includes a maximum-number-of-storage items acquisition unit 2100. Further, the payment apparatus 2000 of Embodiment 6 includes a balance acquisition unit 2120. The balance acquisition unit 2120 has the same function as that of the balance acquisition unit 2120 included in the payment apparatus 2000 of Embodiment 3.

The determination unit 2060 of Embodiment 6 determines whether or not the number of items of a use history stored in a use history acquisition unit 2020 equals to the maximum number of storage items acquired by the maximum-number-of-storage items acquisition unit 2100. In a case where the two equal to each other, the determination unit 2060 determines the total discount value using a use history stored in a second use history storage unit 3020.

In order to determine the total discount value, the determination unit 2060 of Embodiment 6, for example, uses the total value of purchase amounts indicated by a use history associated with the target ID, the balance of a target card, and the total value of depositing amounts for a target card 5000 indicated by the use history associated with the target ID.

<Specific Example of Method of Determining Total Discount Value>

For example, the determination unit 2060 determines the total discount value in the following procedure. Note that, in a case where the total discount value is determined using a method described below, a use history of payment by card stored in a use history storage unit 4020 indicates a purchase price before a discount.

First, the determination unit 2060 determines a sum of the total value of purchase amounts indicated by the use history associated with the target ID and the balance of the target card acquired by the balance acquisition unit 2120. Next, the determination unit 2060 determines a difference between the determined sum and the total value of depositing amounts for the target card 5000 indicated by the use history associated with the target ID. This difference serves as a second total discount value.

In a case where the determination unit 2060 determined to apply a discount, a payment unit 2080 of Embodiment 6 discounts an amount equal to or less than a difference between the discount amount and the second total discount value from the purchase price.

In a case where the number of items of the use history stored in the use history acquisition unit 2020 and the maximum number of storage items acquired by the maximum-number-of-storage items acquisition unit 2100 do not equal to each other, the determination unit 2060 performs the same process as that in the payment apparatus 2000 of Embodiment 3.

<Flow of Processes>

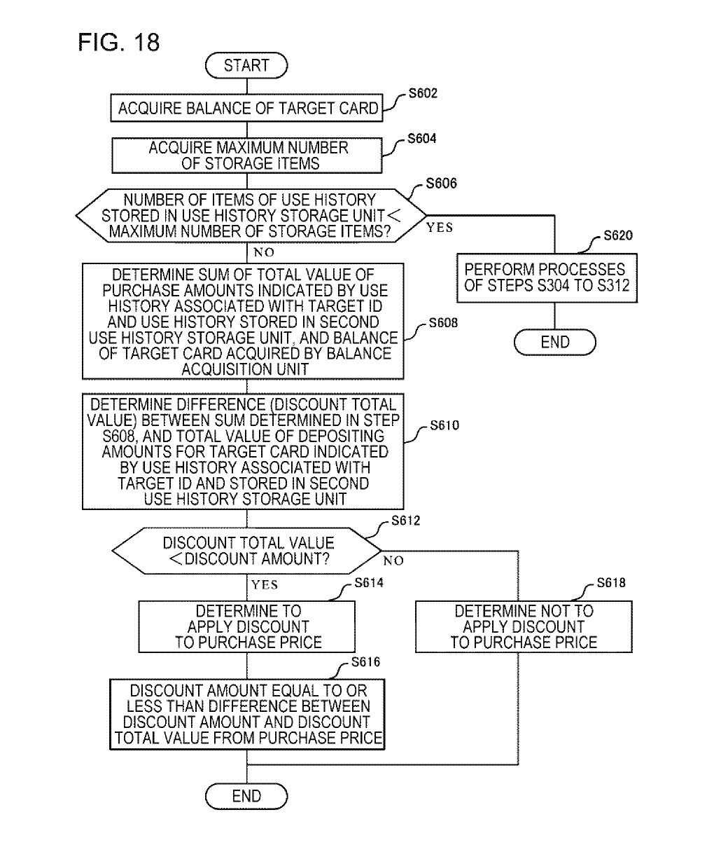

FIG. 18 is a flow diagram illustrating a flow of processes executed by the payment apparatus 2000 of Embodiment 6. In step S602, the balance acquisition unit 2120 acquires the balance of the target card. In step S604, the maximum-number-of-storage items acquisition unit 2100 acquires the maximum number of storage items of the use history capable of being stored in the use history storage unit 4020. In step S606, the determination unit 2060 determines whether or not the number of items of the use history is less than the maximum number of storage items. In a case where the number of items of the use history is not less than the maximum number of storage items (step S606: NO), the process of FIG. 18 proceeds to step S608. On the other hand, in a case where the number of items of the use history is less than the maximum number of storage items (step S606: YES), the process of FIG. 18 proceeds to step S620. In step S620, the payment apparatus 2000 performs processes using the flow shown in steps S304 to S312 of FIG. 9.

In step S608, the determination unit 2060 determines a sum of the balance of the target card acquired by the balance acquisition unit 2120 and the total value of purchase amounts indicated by the use history being associated with to the target ID and being stored in the second use history storage unit 3020. In step S610, the determination unit 2060 determines a difference (total discount value) between the sum determined in step S608 and the total value of depositing amounts for the target card 5000 indicated by the use history being associated with the target ID and being stored in the second use history storage unit 3020.

In step S612, the determination unit 2060 determines whether or not the total discount value is less than the discount amount acquired by the discount amount acquisition unit 2040. In a case where the total discount value is less than the discount amount (step S612: YES), the process of FIG. 18 proceeds to step S614. On the other hand, in a case where the total discount value is equal to or greater than the discount amount (step S612: NO), the process of FIG. 18 proceeds to step S616.

In step S614, the determination unit 2060 determines to apply a discount to the purchase price. In step S616, the payment unit 2080 discounts an amount equal to or less than a difference between the discount amount and the total discount value from the purchase price.

On the other hand, in step S618, the determination unit 2060 determines not to apply a discount to the purchase price.

### Advantageous Effects

In a case where the number of items of the use history stored in the use history acquisition unit 2020 equals to the maximum number of storage items, there is the possibility of that only a portion of the use history of the target card is stored in the use history storage unit 4020. Thus, the payment apparatus 2000 of the present embodiment performs the same process as the process performed by the payment apparatus 2000 of Embodiment 3, using the use history associated with the target ID among the use histories stored in the second use history storage unit 3020. In this manner, even in a case where the number of items of the use history of the target card exceeds the number of items capable of being stored in the use history storage unit 4020, it is achieved to reduce the burden of a user who purchases the target card through multiple discounts by setting the discount amount to an upper limit amount.

### Embodiment 7

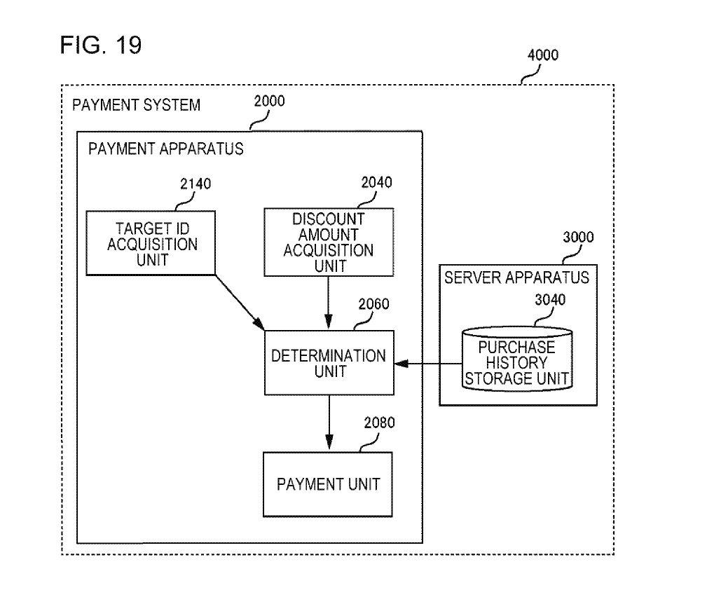

FIG. 19 is a block diagram illustrating a payment system 4000 of Embodiment 7. In FIG. 19, arrows indicate a flow of information. Further, in FIG. 19, each block represents a function-based block rather than a hardware-based configuration.

A server apparatus 3000 of Embodiment 7 includes a purchase history storage unit 3040. The purchase history storage unit 3040 stores a purchase history of a product in association with a user ID or a card ID.

A payment apparatus 2000 of Embodiment 7 includes a discount amount acquisition unit 2040, a determination unit 2060, a payment unit 2080, and a target ID acquisition unit 2140. The discount amount acquisition unit 2040 and the determination unit 2060 have the same functions as those of the discount amount acquisition unit 2040 and the determination unit 2060 that are included in the payment apparatus 2000 of Embodiment 1, respectively. The target ID acquisition unit 2140 has the same function as that of the target ID acquisition unit 2140 of Embodiment 4.

In a case where the purchase history associated with the target ID is not stored in the purchase history storage unit 3040, the determination unit 2060 of Embodiment 7 determines to apply a discount to the purchase price of a product. Therefore, the determination unit 2060 acquires information regarding the purchase history from the purchase history storage unit 3040. A method of causing the determination unit 2060 to acquire information regarding the purchase history from the purchase history storage unit 3040 is the same as, for example, the method of causing the determination units 2060 of Embodiments 4 to 6 to acquire information regarding the use history from the second use history storage unit 3020.

<Flow of Processes>

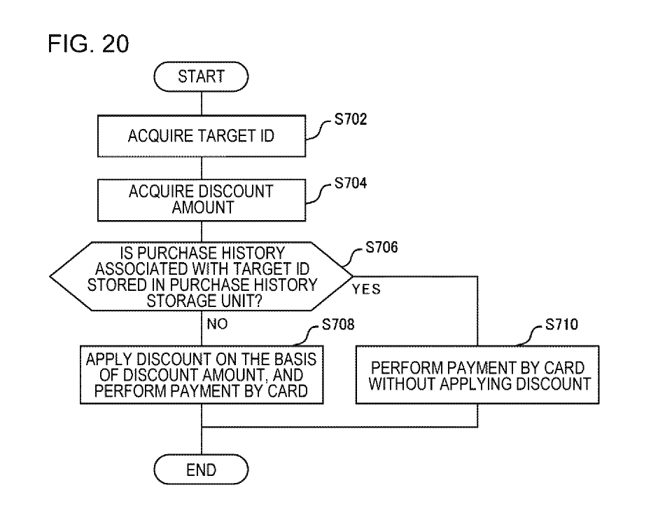

FIG. 20 is a flow diagram illustrating a flow of processes executed by the payment apparatus 2000 of Embodiment 7. In step S702, the target ID acquisition unit 2140 acquires the target ID. In step S704, the discount amount acquisition unit 2040 acquires a discount amount.

In step S706, the payment unit 2080 determines whether or not the purchase history associated with the target ID is stored in the purchase history storage unit 3040. In a case where the purchase history associated with the target ID is not stored in the purchase history storage unit 3040 (step S706: NO), the process of FIG. 20 proceeds to step S708. On the other hand, in a case where the purchase history associated with the target ID is stored in the purchase history storage unit 3040 (step S706: YES), the process of FIG. 20 proceeds to step S710.

In step S708, the payment unit 2080 applies a discount to the purchase price of a product on the basis of the discount amount, and performs payment by card using the target card. On the other hand, in step S710, the payment unit 2080 performs payment by card using the target card without applying a discount to the purchase price of a product.

### Advantageous Effects

According to the payment system 4000 of the present embodiment, in a case where the purchase history associated with the target ID is not stored in the purchase history storage unit 3040, a discount is applied to the purchase amount. Here, since the determination is performed on the basis of the purchase history of a product rather than the use history of a card, it is possible to determine whether or not a discount is applied in further consideration of the purchase of a product that has been performed in the past without using the target card.

For example, the payment system 4000 of the present embodiment is suitable fora case where a system managing the purchase history of a product in association with the user ID or the like is provided separately from a system managing the use history of a card.

### EXAMPLES

Hereinafter, description will be given of examples in which the present invention is carried out using a charging apparatus of an electric automobile as a target. Meanwhile, the examples described below are merely illustrative, and the scope of the present invention is not limited to the charging apparatus of an electric automobile.

### Example 1

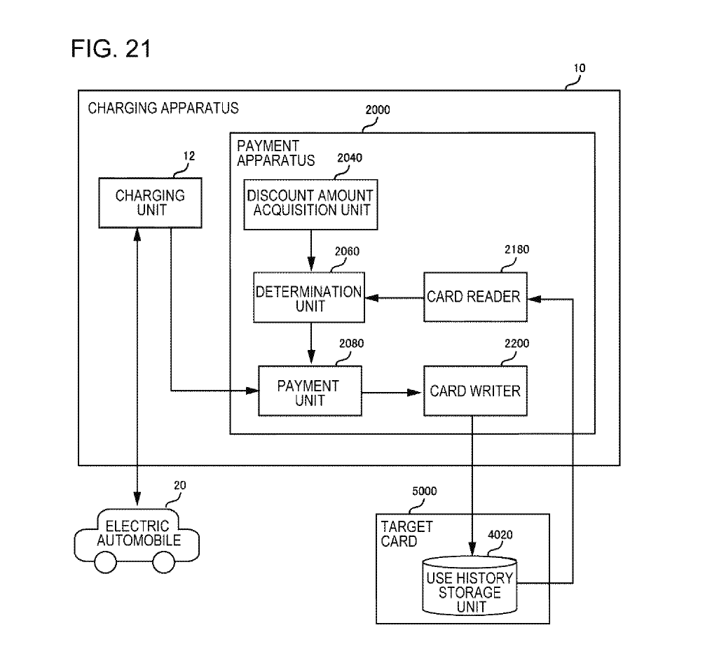

FIG. 21 is a block diagram illustrating a charging apparatus 10 of Example 1 together with its usage environment. In FIG. 21, arrows indicate a flow of information. Further, in FIG. 21, each block represents a function-based block rather than a hardware-based configuration.

The charging apparatus 10 includes a charging unit 12 and a payment apparatus 2000. The charging unit 12 is a functional configuration unit that charges an electric automobile. A user connects an electric automobile 20 to the charging unit 12, and charges the electric automobile 20. The payment apparatus 2000 is an apparatus for paying the usage fee of the charging apparatus 10, and is connected to the charging unit 12. A user pays the usage fee of the charging apparatus 10 through payment by card using a target card 5000. Based on such configurations, in the present example, a product is “a charging service of an electric automobile that is provided by the charging apparatus 10”, and the purchase price of the product is “the usage fee of the charging apparatus 10”. Note that, in the present example, a use history storage unit 4020 is provided inside the target card 5000.

The target card 5000 is used in payment by card for the payment of the usage fee of the charging apparatus 10, or the payment of the purchase prices of other a product. Here, “other products” are products and the like that are purchased at various places (such as a convenience store, a supermarket, or a department store).

A user causes a card reader 2180 of the payment apparatus 2000 to read the target card 5000 in order to perform payment by card the usage fee of the charging apparatus 10. The card reader 2180 reads information stored in the use history storage unit 4020, and transmits the information to a determination unit 2060. The determination unit 2060 determines whether or not to apply a discount to the usage fee of the charging apparatus 10, on the basis of a use history acquired in this manner.

A payment unit 2080 determines the usage fee of the charging apparatus 10 on the basis of information being acquired from the charging unit 12. The information being acquired from the charging unit 12 may be the usage fee itself of the charging apparatus 10, or may be information to be used in determining the usage fee of the charging apparatus 10 (amount of charged power). In addition, the payment unit 2080 determines the amount of payment by card on the basis of the determination result of the determination unit 2060, the usage fee of the charging apparatus 10, and a discount amount acquired from the discount amount acquisition unit 2040. The payment unit 2080 performs payment by card on the determined amount, and transmits information indicating the result of payment by card to a card writer 2200. Here, the information indicating the result of the payment by card is information indicating the amount of payment by card, or the like. The card writer 2200 stores the information received from the payment unit 2080 in the use history storage unit 4020.

The determination unit 2060 determines whether or not to apply a discount to the usage fee of the charging apparatus 10, using various methods described in Embodiments 1 to 3. Further, the use history storage unit 4020 may store the use history in association with the product ID. In this case, for example, the determination unit 2060 determines to apply a discount to the usage fee of the charging apparatus 10, in a case where the use history associated with the product ID indicating “a charging service of an electric automobile that is provided by the charging apparatus 10” is not included in the use histories acquired from the use history storage unit 4020.

Note that, the charging apparatus 10 of “the charging service of an electric automobile that is provided by the charging apparatus 10” is not limited to one apparatus. For example, a plurality of charging apparatuses 10 may be disposed in various places. In addition, the same product ID is allocated to a charging service that is provided by each of the plurality of charging apparatuses 10. In this manner, the determination unit 2060 determines to apply a discount to the usage fee of the charging apparatus 10 in a case where none of the charging apparatuses 10 has been used.

Note that, in a case where there are a plurality of charging apparatuses 10, these charging apparatuses may be divided into groups, and be allocated the product ID for each group. For example, it is considered that a plurality of charging apparatuses 10 disposed in the same store are allocated into the same group, or a plurality of charging apparatuses 10 disposed in the same area are allocated into the same group. This makes it possible to perform an operation such as that “when a charging service is not used in a charging apparatus 10 belonging to a certain specific group, a discount is applied to the usage fee of the charging apparatus 10 belonging to the specific group, even in a case where a charging service has already been used in a charging apparatus 10 belonging to another group”.

### Example 2

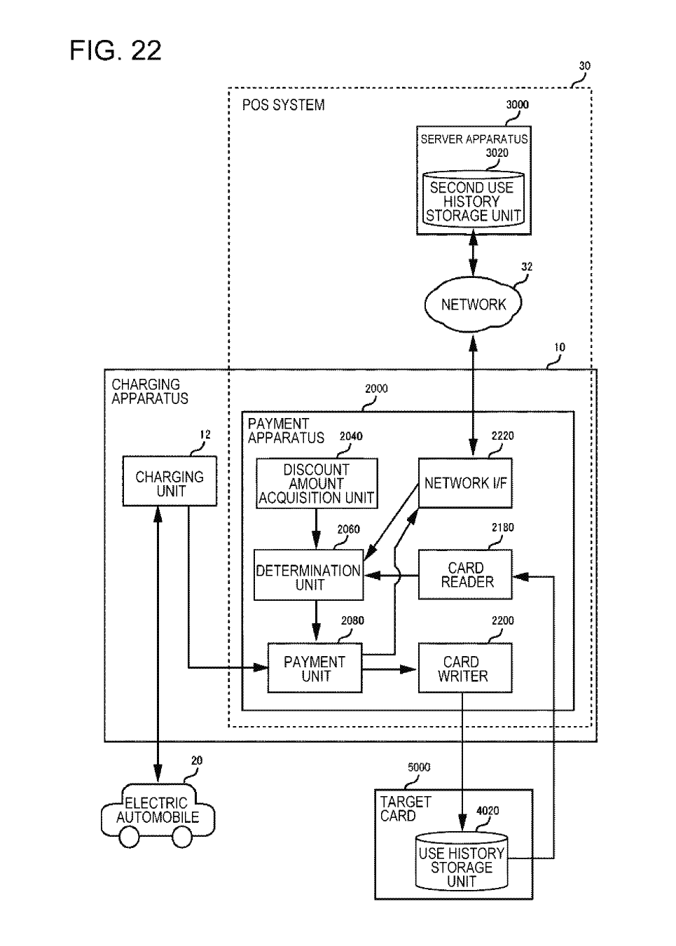

FIG. 22 is a block diagram illustrating a charging apparatus 10 of Example 2 together with its usage environment. In FIG. 22, arrows indicate a flow of information. Further, in FIG. 22, each block represents a function-based block rather than a hardware-based configuration.

A POS (Point of Sale) system 30 includes a payment apparatus 2000, a server apparatus 3000, and a network 32. The network 32 is a network that communicably connects the payment apparatus 2000 to the server apparatus 3000. The payment apparatus 2000 includes a network I/F 2220 that is a network interface for connection to the network 32.

The payment apparatus 2000 of Example 2 has a function included in the payment apparatus 2000 according to any of Embodiments 4 to 6. In a case of FIG. 22, the payment apparatus 2000 has the function of the payment apparatus 2000 according to Embodiment 4.

In Example 2, a card reader 2180 also functions as the target ID acquisition unit 2140 included in each of the payment apparatuses 2000 of Embodiments 4 to 6. For example, the card reader 2180 acquires, as the target ID, an ID of the target card 5000 stored in the target card 5000 or a user ID of a user of the target card 5000.

The use history of the target card 5000 is stored in the use history storage unit 4020 and the second use history storage unit 3020. In the second use history storage unit 3020, the use history of the target card 5000 is stored in association with the aforementioned target ID.

In Example 2, the maximum number of storage items of the use history storage unit 4020 is, for example, approximately several to several tens of items. In a case where the number of the stored use history exceeds the maximum number of storage items, the use history storage unit 4020 erases an oldest use history, and stores a new use history. That is, in a case where the number of times of using the target card 5000 exceeds the maximum number of storage items of the use history storage unit 4020, the use history storage unit 4020 can store only a portion of the use history of the target card 5000. On the other hand, the maximum number of storage items of the second use history storage unit 3020 is greater than the maximum number of storage items of the use history storage unit 4020. Therefore, by using the use history stored in the second use history storage unit 3020, it is possible to refer to even the use history that has been erased due to the incapability of storage in the use history storage unit 4020.

The determination unit 2060 determines whether or not to apply a discount to the usage fee of the charging apparatus 10, using various methods described in Embodiments 4 to 6. Here, in a case where the use history stored in the second use history storage unit 3020 is used, the determination unit 2060 acquires the use history stored in the second use history storage unit 3020, using the network I/F 2220.

The payment unit 2080 determines the amount of payment by card on the basis of the determination result of the determination unit 2060, the usage fee of the charging apparatus 10, and a discount amount acquired from the discount history storage unit 4040. The payment unit 2080 performs payment by card on the determined amount, and transmits information indicating the result of payment by card to the card writer 2200 and the network I/F 2220. The card writer 2200 stores the information received from the payment unit 2080 in the use history storage unit 4020. In addition, the network I/F 2220 transmits the information received from the payment unit 2080 to the server apparatus 3000 through the network 32. The server apparatus 3000 stores the information received from the payment unit 2080 to the second use history storage unit 3020.

### Example 3

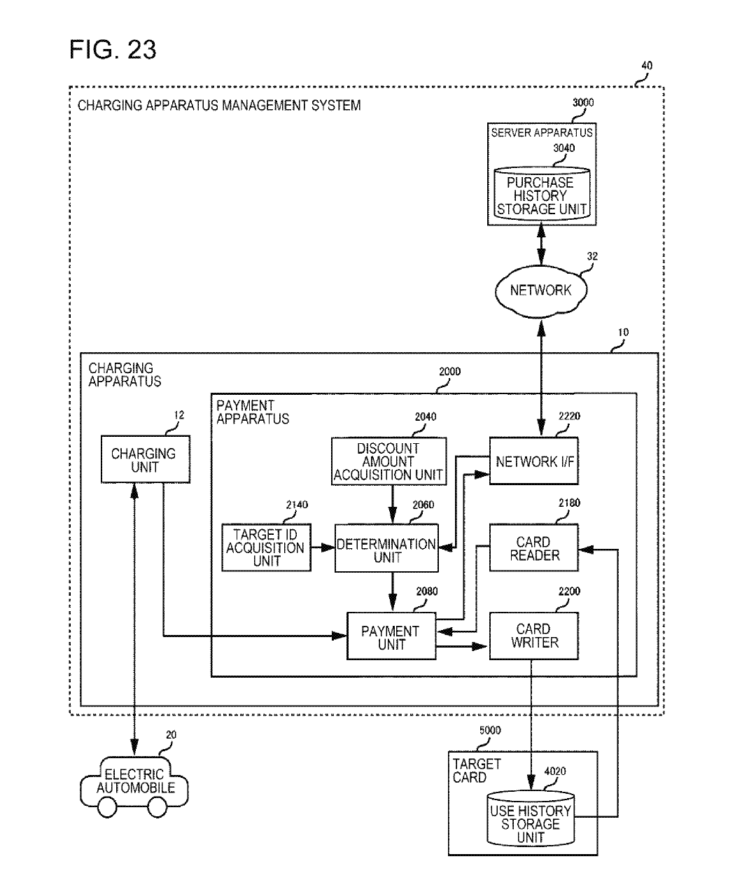

FIG. 23 is a block diagram illustrating a charging apparatus 10 of Example 3 together with its usage environment. In FIG. 23, arrows indicate a flow of information. Further, in FIG. 23, each block represents a function-based block rather than a hardware-based configuration.

A charging apparatus management system 40 includes a charging apparatus 10, a server apparatus 3000, and a network 32. The network 32 is a network that communicably connects the payment apparatus 2000 included in the charging apparatus 10 to the server apparatus 3000.

Example 3 indicates the example of the payment apparatus 2000 of Embodiment 7. The payment apparatus 2000 of Example 3 determines whether or not to apply a discount to the usage fee of the charging apparatus by using the purchase history stored in the purchase history storage unit 3040 instead of the use history of the target card 5000 stored in the use history storage unit 4020. Here, the purchase history in Example 3 is the use history of the charging apparatus 10 (hereinafter, charging history). That is, the payment apparatus 2000 of Example 3 determines whether or not to apply a discount to the usage fee of the charging apparatus 10, on the basis of “whether a charging service provided by the charging apparatus 10 has been used” instead of “whether the usage fee of the charging apparatus 10 has been paid by card using the target card 5000”. Specifically, the payment apparatus 2000 applies a discount to the usage fee of the charging apparatus 10, in a case where the charging history being associated with the target ID is not stored in the purchase history storage unit 3040, in a case where the number of items of the charging history being associated with the target ID stored in the purchase history storage unit 3040 is less than a predetermined number of items, or the like.

In Example 3, the target ID is, for example, a user ID of a user who uses the charging apparatus 10. Furthermore, for example, in a case where a membership card or the like is distributed to a user who uses the charging apparatus 10, the target ID may be a card ID of the membership card.

There are various methods with which the target ID acquisition unit 2140 acquires the target ID. For example, the target ID acquisition unit 2140 acquires a user ID that is manually input by a user. Furthermore, for example, the target ID acquisition unit 2140 reads the membership card to acquire a card ID or a user ID stored in the membership card.

The purchase history storage unit 3040 stores the charging history in association with the target ID. The determination unit 2060 applies a discount to the usage fee of the charging apparatus 10, in a case where the charging history being associated with the target ID acquired by the target ID acquisition unit 2140 is not stored in the purchase history storage unit 3040. When the payment unit 2080 performs a payment for the usage fee of the charging apparatus 10, the payment unit stores the charging history in the purchase history storage unit 3040 through the network I/F 2220. Note that, in the present example, the payment apparatus 2000 may perform a payment for the usage fee of the charging apparatus 10 using methods other than payment by card (for example, payment by cash).

Here, in the present example, a place in which the purchase history storage unit 3040 is provided is not limited to the inside of the server apparatus 3000. For example, the purchase history storage unit 3040 may be provided inside the payment apparatus 2000, or may be provided inside the aforementioned membership card.

As described above, although the embodiments of the present invention have been set forth with reference to the accompanying drawings, the embodiments are merely illustrative of the present invention, and various configurations other than those stated above can be adopted.

This application claims priority from Japanese Application No. 2014-056819 filed on Mar. 19, 2014, the content of which is incorporated herein by reference in its entirety.

1. A payment apparatus comprising:
a discount amount acquisition unit acquiring a discount amount;
a determination unit determining whether or not to apply a discount to payment by card using a target card on the basis of a use history of the target card, the target card being electronic money card of a target; and
a payment unit applying a discount to payment by card using the target card on the basis of the discount amount, in a case where the determination unit determines to apply a discount.

2. The payment apparatus according to claim 1, wherein the determination unit determines whether or not the target card has been used in payment by card, and determines to apply a discount in a case where the target card has never been used in payment by card.

3. The payment apparatus according to claim 2, wherein in a case where the use history indicating payment by card is not present, the determination unit determines that the target card has never been used in payment by card.

4. The payment apparatus according to claim 2, further comprising a maximum-number-of-storage items acquisition unit acquiring a maximum number of storage items of the use history capable of being stored in a use history storage unit that stores the use history,
wherein the determination unit determines that the target card has never been used in payment by card, in a case where the use history indicating payment by card is not stored in the use history storage unit and the number of items of the use history stored in the use history storage unit is less than the maximum number of storage items.

5. The payment apparatus according to claim 1, wherein the determination unit determines to apply a discount, in a case where a total amount of discounts applied to purchase of products using the target card is smaller than the discount amount.

6. The payment apparatus according to claim 5, further comprising a balance acquisition unit acquiring a balance of the target card,
wherein the determination unit determines a total discount value that is the total amount of discounts applied to the purchase of products using the target card, using a total value of purchase prices indicated by the use history, the balance, and a total value of depositing amounts for the target card indicated by the use history.

7. The payment apparatus according to claim 1,
wherein the payment apparatus is communicably connected to a server apparatus including a second use history storage unit that stores the use history of the target card in association with a target ID,
wherein the target card includes a use history storage unit storing the use history,
wherein the payment apparatus further comprises a target ID acquisition unit acquiring the target ID, and
wherein the determination unit determines whether or not to apply a discount to the purchase price, on the basis of the use history stored in the use history storage unit and the use history stored in the second use history storage unit.

8. The payment apparatus according to claim 7, further comprising a maximum-number-of-storage items acquisition unit acquiring a maximum number of storage items of the use history capable of being stored in the use history storage unit,
wherein the determination unit performs: determining whether or not the use history being associated with the target ID and indicating payment by card is stored in the second use history storage unit, in a case where the use history indicating payment by card is not stored in the use history storage unit, and the number of items of the use history stored in the use history storage unit equals to the maximum number of storage items; and determining to apply a discount when the use history being associated with the target ID and indicating payment by card is not stored in the second use history storage unit.

9. The payment apparatus according to claim 7, further comprising:
a maximum-number-of-storage items acquisition unit acquiring a maximum number of storage items of the use history capable of being stored in the use history storage unit; and
a balance acquisition unit acquiring a balance of the electronic money card,
wherein the determination unit performs: determining a second total discount value being a total amount of discounts applied to purchase of products using the target card, using a total value of purchase amounts indicated by the use history being associated with the target ID, the balance, and a total value of depositing amounts for the target card indicated by the use history being associated with the target ID, in a case where the number of items of the use history stored in the use history storage unit equals to the maximum number of storage items, and determining to apply a discount in a case where the second total discount value is smaller than the discount amount, and
wherein the payment unit discounts an amount equal to or less than a difference between the discount amount and the second total discount value from the purchase price, in a case where the determination unit determines to apply a discount.

10. The payment apparatus according to claim 8,
wherein the use history indicating payment by card stored in the second use history storage unit is further associated with a product ID of a product that is a target for payment by card, and
wherein the determination unit uses a use history in which an associated product ID is a predetermined ID, among the use histories stored in the second use history storage unit.

11. A payment apparatus being communicably connected to a server apparatus including a purchase history storage unit that stores a purchase history of a product in association with a target ID, the apparatus comprising:
a target ID acquisition unit acquiring the target ID;
a discount amount acquisition unit acquiring a discount amount;
a determination unit determining to apply a discount to a purchase price of a product, in a case where the purchase history being associated with the target ID is not stored in the purchase history storage unit; and
a payment unit applying a discount to the purchase price of a product on the basis of the discount amount in a case where the determination unit determines to apply a discount, and performs payment by card using an electronic money card.

12. A control method being executed by a computer, the method comprising:
a discount amount acquisition step of acquiring a discount amount;
a determination step of determining whether or not to apply a discount to payment by card using a target card on the basis of a use history of the target card, the target card being electronic money card of a target; and
a payment step of applying a discount to payment by card using the target card on the basis of the discount amount, in a case where it is determined to apply a discount in the determination step of determining whether or not to apply a discount to payment by card using a target card.

13. The control method according to claim 12, wherein in the determination step of determining whether or not to apply a discount to payment by card using a target card, it is determined whether or not the target card has been used in payment by card, and determines to apply a discount in a case where the target card has never been used in payment by card.

14. The control method according to claim 13, wherein in the determination step of determining whether or not to apply a discount to payment by card using a target card, it is determined that the target card has never been used in payment by card in a case where the use history indicating payment by card is not present.

15. The control method according to claim 13, further comprising a maximum number of storage items acquisition step of acquiring a maximum number of storage items of the use history capable of being stored in a use history storage unit that stores the use history,
wherein in the determination step of determining whether or not to apply a discount to payment by card using a target card, it is determined that the target card has never been used in payment by card, in a case where the use history indicating payment by card is not stored in the use history storage unit and the number of items of the use history stored in the use history storage unit is less than the maximum number of storage items.

16. The control method according to claim 12, wherein in the determination step of determining whether or not to apply a discount to payment by card using a target card, it is determined to apply a discount, in a case where a total amount of discounts applied to purchase of products using the target card is smaller than the discount amount.

17. The control method according to claim 16, further comprising a balance acquisition step of acquiring a balance of the target card,
wherein in the determination step of determining whether or not to apply a discount to payment by card using a target card, a total discount value that is the total amount of discounts applied to the purchase of products using the target card is determined using a total value of purchase prices indicated by the use history, the balance, and a total value of depositing amounts for the target card indicated by the use history, and it is determined that a discount is applied in a case where the total discount value is smaller than the discount amount, and
wherein, in the payment step, an amount equal to or less than a difference between the discount amount and the total discount value is discounted from the purchase price in a case where it is determined in the determination step that a discount is applied.

18. The control method according to claim 12,
wherein the computer is in a state of being communicably connected to a server apparatus including a second use history storage unit that stores the use history of the target card in association with a target ID,
wherein the target card includes a use history storage unit storing the use history,
wherein the method further comprises a target ID acquisition step of acquiring a target ID, and
wherein, in the determination step of determining whether or not to apply a discount to payment by card using a target card, it is determined whether or not to apply a discount to the purchase price, on the basis of the use history stored in the use history storage unit and the use history stored in the second use history storage unit.

19. The control method according to claim 18, further comprising a maximum number of storage items acquisition step of acquiring a maximum number of storage items of the use history capable of being stored in the use history storage unit,
wherein, in the determination step of determining whether or not to apply a discount to payment by card using a target card,
it is determined whether or not the use history being associated with the target ID and indicating payment by card is stored in the second use history storage unit, in a case where the use history indicating payment by card is not stored in the use history storage unit, and the number of items of the use history stored in the use history storage unit equals to the maximum number of storage items, and
it is determined to apply a discount when the use history being associated with the target ID and indicating payment by card is not stored in the second use history storage unit.

20. The control method according to claim 18, further comprising:
a maximum number of storage items acquisition step of acquiring a maximum number of storage items of the use history capable of being stored in the use history storage unit; and
a balance acquisition step of acquiring a balance of the electronic money card,
wherein, in the determination step of determining whether or not to apply a discount to payment by card using a target card, a second total discount value being a total amount of discounts applied to purchase of products using the target card is determined using a total value of purchase amounts indicated by the use history being associated with the target ID, the balance, and a total value of depositing amounts for the target card indicated by the use history associated with the target ID, in a case where the number of items of the use history stored in the use history storage unit equals to the maximum number of storage items, and it is determined to apply a discount in a case where the second total discount value is smaller than the discount amount, and
wherein, in the payment step of applying a discount to payment by card using the target card, an amount equal to or less than a difference between the discount amount and the second total discount value is discounted from the purchase price in a case where it is determined to apply a discount in the determination step.

21. The control method according to claim 19,
wherein the use history indicating payment by card stored in the second use history storage unit is further associated with a product ID of a product that is a target for payment by card, and
wherein, in the determination step of determining whether or not to apply a discount to payment by card using a target card, a use history in which a corresponding product ID is a predetermined ID is used, among the use histories stored in the second use history storage unit.

22. A control method, in a state of being executed by a computer being communicably connected to a server apparatus, the server apparatus having a purchase history storage unit step of storing a purchase history of a product in association with a target ID, the method comprising:
a target ID acquisition step of acquiring the target ID;
a discount amount acquisition step of acquiring a discount amount;
a determination step of determining to apply a discount to a purchase price of a product in a case where the purchase history being associated with the target ID is not stored in the purchase history storage unit; and
a payment step of applying a discount to the purchase price of a product on the basis of the discount amount in a case where it is determined to apply a discount in the determination step, and performing payment by card using an electronic money card.

23. A non-transitory computer-readable storage medium storing a program causing a computer to have a function of operating as a payment apparatus, the program causing the computer to execute:
a discount amount acquisition function of acquiring a discount amount;
a determination function of determining whether or not to apply a discount to payment by card using a target card on the basis of a use history of the target card, the target card being electronic money card of a target; and
a payment function of applying a discount to payment by card using the target card on the basis of the discount amount, in a case where the determination unit determines to apply a discount.

24.-33. (canceled)

34. A payment system comprising the payment apparatus and the server apparatus according to claim 7.
